(19) United States
(12) Patent Application Publication
(10) Pub. No.: US 2003/0080267 A1
(43) Pub. Date: May 1, 2003

(54) Multi-sized clamp

(75) Inventor: William Robert Eslick, Canoga Park, CA (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(73) Assignee: Panavision, Inc.

(21) Appl. No.: 10/046,215

(22) Filed: Oct. 29, 2001

(51) Int. Cl. F16B 1/00; E04G 3/00; G09F 7/18

(52) U.S. Cl. 248/229.1; 248/229.14

(57) ABSTRACT

A multi-sized clamp capable of attaching to various sized cylindrical objects such as iris rods of a professional movie camera. The multi-sized clamp includes a pair of clamp jaws connected by a hinge and a pivotable adjustment rod. The clamp jaws' interior surfaces include curved surfaces having at least two different diameters. The clamp jaws are opened by turning the pivotable adjustment rod in one direction and closed by turning it in the opposite direction. One of the clamp jaws also contains a body that also has an opening and an L-shaped split above the opening with a closing mechanism running through the body above the opening and through the split. The closing mechanism when turned in one direction increases the opening and decreases the opening when turned in the opposite direction, thus allowing other equipment to be attached to the clamp through the opening.

### BACKGROUND OF THE INVENTION

The field of the present invention relates to a clamp for attaching a device to a cylindrical object. In particular, the invention relates to a clamp capable of attaching various devices to cylindrical objects of various diameters.

In the entertainment industry, motion picture cameras typically have many different accessories attached to them in order for the cameras to capture the images that are desired. Typical accessories are lens lights, flags, LCD monitors and lens drive assemblies and motors. These accessories attach to the iris rods found on the front of the cameras. These accessories typically have built in clamps that are sized to a specific sized cylindrical object. Since the clamps on these accessories are sized to a specific cylindrical object, when the cylindrical object is of a different size, a different accessory is required that will fit that cylindrical object.

Other accessories have clamps that are replaceable, such that when the clamp currently on the accessory is of a different size than the iris rod on the camera, the clamp can be removed and replaced with a clamp of the appropriate size. This, however, requires a selection of clamps to be on hand so that the accessory can fit any camera that is used.

Since different camera manufacturers use different sized iris rods on their cameras, switching all of the accessories or the replaceable clamps on the accessories that may be on a camera at a given point in time to fit the different iris rods is an undesirable step. Also, this requires a camera rental company to maintain a large inventory of different sizes of clamps or a large inventory of accessories with integral clamps of varying sizes. Thus, it has been desirable to have a clamp that can fit varying sizes of iris rods to avoid having to replace the accessories or the replaceable clamps that attach to the accessories. Having a clamp that can fit varying sizes of iris rods is also desirable because it is less expensive than having a number of accessories or clamps. Therefore, a clamp that is capable of clamping to iris rods of several different sizes would be more economical and efficient and would reduce the number of accessories required.

Furthermore, equipment that is clamped onto cylindrical objects typically is sized to fit a specific sized cylindrical object. Like with the accessories that are attached to movie cameras, other equipment either has integral clamps that are sized to a specific diameter or have a clamp that is replaceable when a larger or smaller diameter clamp is needed. This is also inefficient, as it requires either having inventory of equipment in stock that will fit a specific cylindrical object, or an inventory of clamps of varying diameters to fit each specific cylindrical object. Thus there is also a need to have a clamp that can fit cylindrical objects that can be attached to any piece of equipment such that the clamp can fit onto varying sizes of cylindrical objects.

### SUMMARY OF THE INVENTION

The present invention provides an improved clamp for attaching objects to cylindrical objects of varying diameters. The multi-size clamp of the present invention includes a pair of clamp jaws connected by a hinge and a pivotable adjustment rod assembly. The clamp jaws contain interior curved surfaces with the curved surfaces having curves of at least two different diameters. These curved surfaces are used to attach the clamp to at least two different diameters of cylindrical objects, such as iris rods on a movie camera.

The cylindrical object is placed into the clamp with one of the clamp jaws in the open position. Once the cylindrical object is in place, the clamp is closed around the object using the pivotable adjustment rod assembly. As the pivotable adjustment rod assembly is rotated, one of the clamp jaws is forced downward toward the cylindrical object until the clamp jaw comes into contact with the cylindrical object and thus locks the clamp in place on the cylindrical object. When the pivotable adjustment rod assembly is rotated the opposite direction, the clamp jaw is opened and the clamp is released from the cylindrical object.

One of the clamp jaws also contains a body that is provided with an attachment clamp. The attachment clamp in the body of the clamp jaw consists of an opening with the body split such that the opening can be increased and decreased. A closing mechanism runs through the body of the clamp jaw above this opening such that when it is rotated in one direction, the opening is enlarged and when it is rotated in the opposite direction, the opening decreases. This allows equipment to be attached to the clamp. An example would be a lens light that could be attached to the clamp and the clamp then attached to the iris rod on the front of a camera. However, the clamp can also be used to attach just about any other piece of equipment to it such that the piece of equipment has a means for fitting in the opening in the body of the clamp jaw.

### BRIEF DESCRIPTION OF THE DRAWINGS

FIG. 1 is an isometric view of the multi-sized clamp in the open position;

FIG. 2 is a side elevation view of the multi-sized clamp in the open position;

FIG. 3 is an isometric assembly view of the multi-sized clamp showing how one clamp jaw is connected to the other clamp jaw;

FIG. 4 is a sectional view taken along line 4-4 from FIG. 1;

FIG. 4A is a partial sectional view of the pivotable adjustment rod assembly;

FIG. 5 is a side elevation view of the clamp in the closed position around the smallest diameter rod

FIG. 6 is a side elevation view of the clamp in the closed position around a larger diameter rod;

FIG. 7 is a side elevation view of the clamp in the closed position around the largest diameter rod;

FIG. 8 is a partial sectional view taken along line 4-4 from FIG. 1, with the clamp in the fully open position; and

FIG. 9 is a partial sectional view taken along line 4-4 from FIG. 1, with the clamp in the closed position.

### DETAILED DESCRIPTION OF THE PREFERRED EMBODIMENTS

The preferred embodiment of the present invention will now be described with reference to the drawings. To facilitate the description, a reference numeral representing an element in one figure will represent the same element in any other figure.

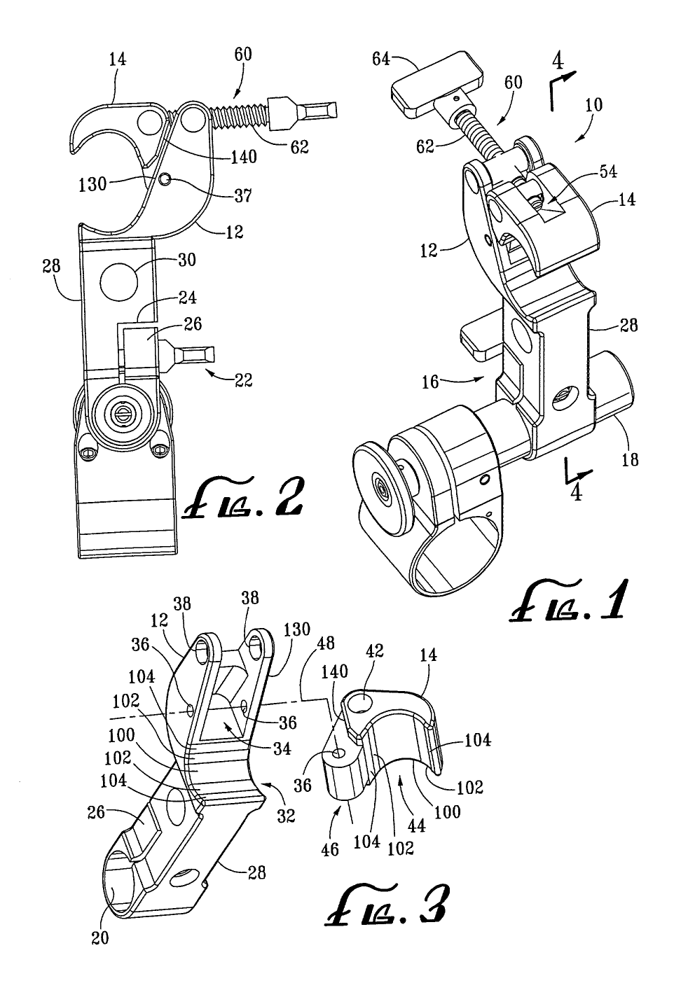

Referring now to FIG. 1, the multi-sized clamp 10 is shown in the open position. The multi-sized clamp 10 includes a lower clamp jaw 12 and an upper clamp jaw 14. The lower clamp jaw body 28 preferably has a clamping mechanism 16 for attaching equipment, such as lens lights, flags, LCD monitors, lens drive assemblies or motors or any other type of equipment (not shown), to the multi size clamp.

Referring also to FIGS. 2, 3 and 4, the clamping mechanism 16 consists of an opening 20 at the bottom of the lower clamp jaw body 28. The lower clamp jaw body 28 is split in an inverted L-shape 24 above the opening 20, allowing the side 26 of the lower clamp body to extend outward such that the opening 20 can be allowed to expand and be decreased in size by a closing mechanism 22, as best viewed in FIG. 4. A rod 18 can be inserted into the opening 20 of the clamping mechanism 16 when the closing mechanism is in a released position such that the opening 20 is allowed to expand and increase in size to allow the rod 18 to pass through the opening 20.

The closing mechanism 22 includes of a threaded spindle 110 and a screw 115. The lower clamp jaw body 28 has a hole 125 through it perpendicular to and above the opening 20, which passes through the inverted L-shaped split 24. A portion 125A of the hole 125 is a small diameter hole through the left portion of body 28 (as viewed in FIG. 4) with clearance for spindle 110. Both sides of the hole 125 preferably are counterbored so that the outer portion 126 of the hole 125 has a larger diameter than the interior portion 125. A portion 125B of the hole 125 on the right hand side of the lower clamp jaw body 28 opposite the inverted L-shaped split 24 can be threaded so that the threaded spindle 110 threadably engages directly (not shown) with the lower clamp jaw body 28. However, it is preferred that the portion 125B of the hole 125 on that side of the lower clamp jaw body 28 opposite the L-shaped split 24 be larger than the smaller portion 125A of the hole 125 on the other side of the lower clamp jaw body 28 and threaded for receiving an insert 120 threadably engaged with this portion 125B of the hole 125. The insert 120 has external threads and also a threaded hole through the insert.

The spindle 110 is an externally threaded rod with a threaded hole at one end of the rod. The spindle 110 is sized such that it will threadably engage with either the afore-described threaded portion (not shown) of the hole portion 125B or the threaded insert 120. A spindle handle 129 is attached to the spindle 110 opposite the end of the rod with the threaded hole. Once the spindle 110 is inserted into the hole 125 and threadably engaged with the threaded insert 120, the screw 115 is then threadably engaged with the spindle 110, securing the spindle from becoming unthreaded from insert 120. The screw 115, however, could be in the form of any other mechanism to prevent the spindle from being removed from hole 125, such as a retaining ring or nut. The spindle 110 can then be rotated either direction using the spindle handle 129. The spindle handle 129 has a base portion sized to fit within the larger portion 126 of the hole 125. When the spindle 110 is turned in one direction, the spindle moves inward through the threaded insert 120. The base portion of the spindle handle 129 comes into contact with side 26, inside the larger portion of the hole 126, thus forcing side 26 inward. This inward movement of side 26 decreases the opening 20 thereby engaging the sides of the opening 20 with the rod 18 which secures the clamp to the rod 18 and prevents any further movement of the clamp either around or along the rod 18. When the closing mechanism 22 is turned in the opposite direction, the opening 20 is allowed to increase in size, thereby releasing the sides of the opening 20 from the rod 18 which allows the clamp to move along the rod 18. Other equipment or clamps can be attached to rod 18, such as lens lights, flags, LCD monitors, lens drive assemblies or motors, or any other type of equipment.

The lower clamp jaw body 28 has a hole 30 through the body 28 above the clamping mechanism 16 and below the lower clamp jaw 12. This hole 30 is used to decrease the weight of the lower clamp body, but does not reduce the strength of the lower clamp jaw body 28.

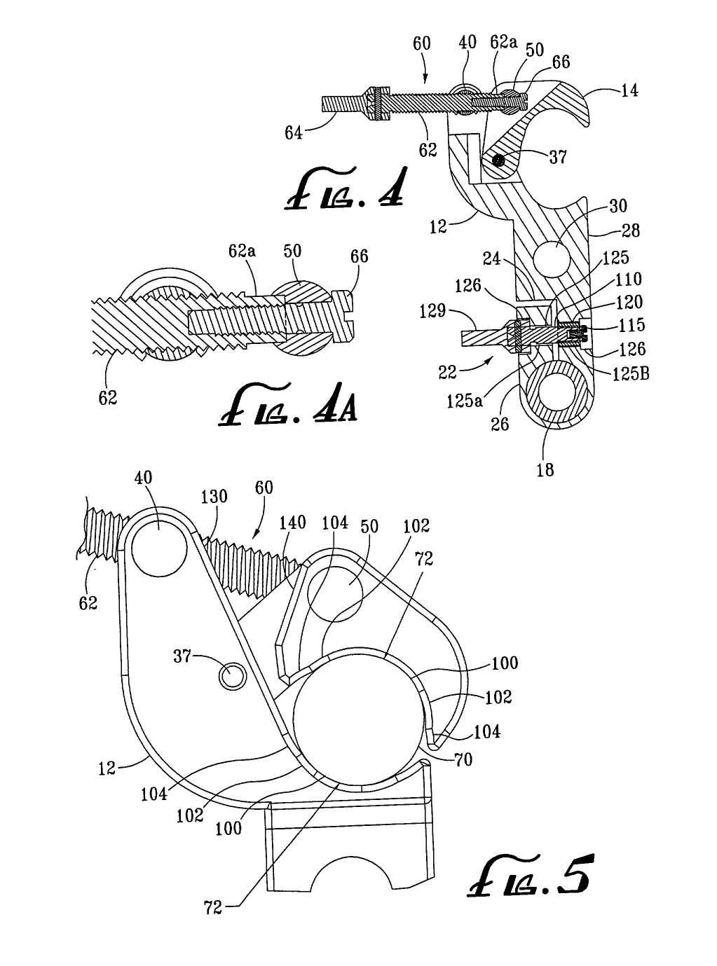

Referring now to FIG. 3, the lower clamp jaw 12 and upper clamp jaw 14 are shown in a disassembled state. The lower clamp jaw 12 has an interior curved surface 32. The curved surface 32 has curves of at least two diameters. In the preferred embodiment, the interior curved surface 32 has curves of three different diameters. The smallest diameter curved surface 100 is generally in the middle of the lower clamp jaw interior surface 32. Next, a pair of curved surfaces 102 have a diameter that is larger than the smallest diameter, but smaller than the largest diameter. The curved surfaces 102 are on each side of curved surface 100. The curved surfaces 102 are substantially smaller in area than the curved surface 100, but occur at two locations on the interior curved surface 32. The largest diameter curved surfaces 104 are on each side of the curved surfaces 102. In the preferred embodiment, there are three curved surfaces and the diameters of each of the curved surfaces are 0.590 inches, 0.620 inches and 0.748 inches, which are the sizes of three conventional iris rods for cameras, however, the curved surfaces 100, 102 and 104 can be of any diameter. Additionally, the clamp could be made with only two curved surfaces and any combination of two of the three different diameters could be used in a clamp with only two curved surfaces.

The surface 130, above interior surface 32, has a generally U-shaped slot 34 cut into the surface. The slot 34 does not cut all the way through the lower clamp jaw 12. The slot 34 starts above the end of the last curve 104 on surface 130 and extends to the top of the lower clamp jaw 12. At the top of the lower clamp jaw, the slot extends completely through the lower clamp jaw 12.

On each side of the slot 34, there are first holes 36 and second holes 38. The first holes 36 are for a hinge pin 37 (shown in FIGS. 4-7), used to connect the lower clamp jaw 12 to the upper clamp jaw 14. The second holes 38 are provided for a pivot pin 40 (shown in FIGS. 4-7).

The upper clamp jaw 14 also has an interior curved surface 44. The curved surface 44 has curves of at least two diameters. In the preferred embodiment, the curved surface 44 has curves of three different diameters. The curved surfaces 100, 102 and 104 of the interior curved surface 44 are the same as those for the lower clamp jaw 12 interior curved surface 32. On the side of the upper clamp jaw 14 which connects to the lower clamp jaw 12, the upper clamp jaw narrows below the end of the last curved surface 104, such that the narrow portion 46 of the upper clamp jaw 12 can fit inside the slot 34 of the lower clamp jaw 12. The narrow portion 46 of the upper clamp jaw 14 contains hole 36. When the upper clamp jaw 14 is connected to the lower clamp jaw 12 by the hinge pin 37, the holes 36 in both the upper clamp jaw 12 and lower clamp jaw 14 are aligned along centerline 48.

The upper clamp jaw 14 also contains holes 42, which are sized to fit the keeper clamp 50 (shown in FIG. 4). The side opposite the interior curved surface 44 of the upper clamp jaw 14 also has a channel 54 cut into the upper clamp jaw 14 as can be seen in FIG. 1. The channel 54 allows for the movement of the pivotable adjustment rod assembly 60 as the upper clamp jaw 14 is opened and closed.

The pivotable adjustment rod assembly 60 comprises several interconnected components that are similar in the two embodiments shown, but differ in some details. The main component of the assembly is the spindle 62. The spindle 62 is a threaded rod. One end of the rod is narrower than the rest of the rod. The narrow end 62a of the spindle 62 contains an axially extending threaded hole. The end opposite the narrow end 62a of the spindle 62 has a handle 64 so that the spindle can be easily rotated in either direction. The screw 66 is sized so that it is threadably engageable with the hole in the narrow end 62a of the spindle 62. The length of the narrow end 62a differs for the two embodiments shown. The head of the screw 66 is preferably slotted such that a flat head screwdriver can be used to turn the screw 66. However, the screw head could be made to fit any type of screwdriver or wrench. Additionally, in place of the screw 66, any other mechanism could be used which will secure the spindle 62 in place, such as a retaining ring or nut, but will allow rotation of the spindle 62. The pivot pin 40 is inserted into the holes 38 in the lower clamp jaw 12. The pivot pin 40 contains a threaded hole through the center of the pivot pin 40. This threaded hole is sized to match the threaded rod portion of the spindle 62.

In the preferred embodiment shown in FIGS. 4 and 4A, the keeper clamp 50 is inserted into the holes 42 in the upper clamp jaw 14. The keeper clamp 50 contains a hole sized to fit a non-threaded, smooth portion of the screw 66, whereby the screw 66 does not threadably engage with the keeper clamp 50. This hole is in the center of the keeper clamp 50. The screw 66 is inserted through this hole after the keeper clamp 50 is inserted into the upper clamp jaw 14. The side of the keeper clamp 50 that engages with the head of the screw 66 is flattened to provide a better contact surface. The side opposite this flat section of the keeper clamp 50 contains either a larger diameter countersunk hole or in the alternative, a flat section. This larger diameter hole only partially penetrates the keeper clamp 50 and is sized such that the narrow end 62a of the spindle 62 can fit inside that countersunk opening and the end of the spindle comes into contact with the keeper clamp 50. Once the pivot pin 40 and the keeper clamp 50 are inserted into the lower clamp jaw 12 and upper clamp jaw 14, the spindle 62 is threaded into the pivot pin 40 and positioned against the keeper clamp 50 respectively. The threaded end of the screw 66 can then be inserted through the hole in keeper clamp 50 and threadably engaged with the spindle 62, securing the spindle in place, however, other means could be used to secure the spindle in place, such as a retaining ring or nut. The length of screw 66 and the depth of the threaded hole in spindle 62 are predetermined so that the screw 66 bottoms-out in the hole to establish a predetermined space between the screw head and the end of the spindle. This predetermined space allows free rotation of the spindle 62 without any significant axial movement. Washers may be provided on either side of keeper clamp 50 for enhancing this ability to rotate spindle 62. Once engaged, rotation of the spindle 62 will cause the upper clamp jaw 14 to either open or close, depending on the direction that the spindle 62 is rotated. As the spindle 62 is rotated in one direction, the spindle 62 moves toward the upper clamp jaw 14 and pushes against the keeper clamp 50, which forces the upper clamp jaw 14 down toward the lower clamp jaw. This will cause the spindle 62 and the screw 66 to pivot downward toward the lower clamp jaw. The pivot pin 40 and the keeper clamp 50 are free to rotate in the holes 38 and 42 and thus allow the rotation of the spindle 62 and the screw 66. In this manner, the alignment of the components of the pivotal adjustment rod assembly 60 is maintained.

In the preferred embodiment of FIGS. 8 and 9, the keeper clamp 50 is inserted into the holes 42 in the upper clamp jaw 14. The keeper clamp 50 contains a hole sized to fit the narrow end 62a of the spindle 62, such that the narrow end 62a of the spindle 62 passes completely through the keeper clamp 50. Both sides of the keeper clamp are flattened or counterbored where the spindle 62a passes through. Washers 52 are placed on both sides of the keeper clamp 50 prior to inserting the narrow end 62a through the keeper clamp 50. Once the narrow end 62a is inserted into the keeper clamp 50, screw 66 is threadably engaged with the threaded hole in the narrow end 62a of the spindle 62 and, with the washers 52, prevents any significant axial movement of the spindle 62 relative to the keeper clamp 50 while allowing relative rotation. The screw 66 can be replaced by any mechanism to secure the spindle 62 in this manner, such as a retaining ring or nut. The spindle 62 when turned by handle 64 will now threadably move through the pivot pin 40 in either direction without the screw 66 turning relative to the spindle 62. When the spindle 62 is turned in one direction, the spindle 62 will move in a direction which draws the spindle 62 toward the direction of the handle 64 and will cause the upper clamp jaw 14 to open, as in FIG. 8. When the spindle 62 is turned in the opposite direction, the spindle 62 will move toward the upper clamp jaw 14, thus pushing the upper clamp jaw 14 down toward the lower clamp jaw 12, as in FIG. 9. The pivotable adjustment rod assembly 60 (spindle 62 etc.) will pivot relative to the lower clamp jaw 12 and upper clamp jaw 14 as the spindle 62 is rotated due to the freely rotatable pivot pin 40 and keeper clamp 50 within holes 38 and 42. This pivoting allows the components of the pivotable adjustment rod assembly 60 to maintain their alignment.

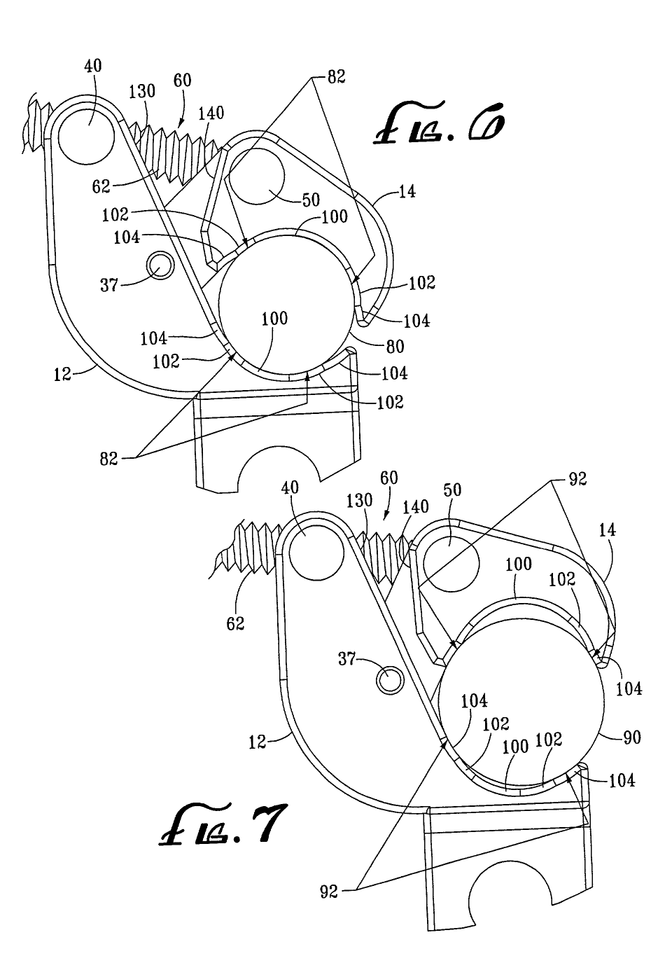

Referring now to FIG. 5, the multi-sized clamp 10 is shown in the closed position around a small diameter rod 70. When the clamp is closed around a small diameter rod 70, the interior curved surfaces 100 on both the upper and lower clamp jaws engage with the rod 70 in the locations shown by the arrows 72 in FIG. 5. In the preferred embodiment, the smallest diameter rod 70 is 0.590 inches and the interior curved surfaces 100 have a diameter of 0.590 inches. This small diameter, however, can be any diameter, such that it matches the diameter of the rod that it clamps to.

As can be seen in FIG. 5, the pivotable adjustment rod assembly 60 is shown with the upper clamp jaw 14 in the closed position. The pivotable adjustment rod assembly 60 is shown rotated downward toward the lower clamp jaw 12.

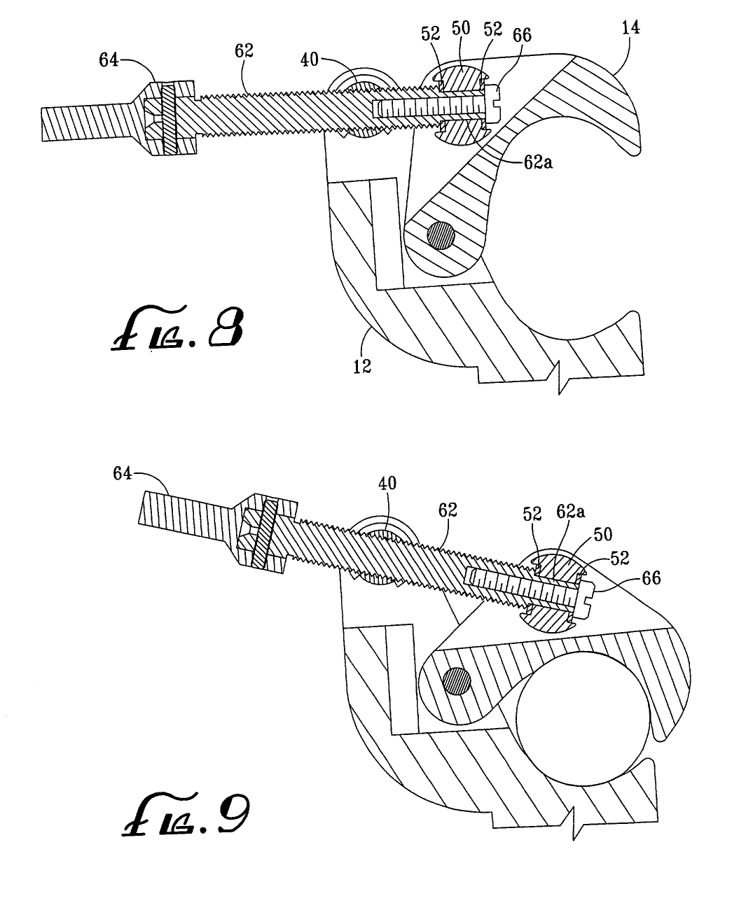

When a larger diameter rod 80 is inserted into the clamp, the upper clamp jaw 14 does not rotate downward as far as with the smaller diameter rod 70. The interior curved surfaces 102 on the upper and lower clamp jaw then engage the rod 80 at different points than with the smaller diameter rod 70. The rod 80 engages the interior surfaces 102 of each of the clamp jaws at two spaced locations instead of one continuous location, as with the small diameter rod 70, as can be seen in FIG. 6. The arrows 82 indicate the points that the rod 80 engage with the upper clamp jaw 14 interior curved surface 44 and the lower clamp jaw 12 interior curved surface 32. The interior curved surfaces 102 are curved to match the diameter of the rod 80. In the preferred embodiment, the curved surface diameter and the rod diameter are 0.620 inches, however, any diameter could be used such that the diameter matches the rod diameter and it is larger than the small diameter of the previous rod. The rod 80 only engages the upper and lower clamp jaws at the locations indicated by the arrows 82. The rod does not engage with the interior curved surface 100 of the upper and lower clamp jaw. This clearance can be more clearly seen with the largest rod in FIG. 7.

In FIG. 7, the clamp is engaged with the largest diameter rod 90 that can be placed in the clamp. The arrows 92 indicate the engagement points between the rod and the clamp. The rod 90 engages with the interior curved surfaces 104 on the upper and lower clamp jaws. The rod does not engage with the interior curved surfaces 100 and 102 where the diameters of the curved surface are smaller than the present diameter of the rod 90. In the preferred embodiment, the diameter of the rod 90 and the interior curved surfaces 104 of the upper and lower clamp is 0.748 inches, however, any diameter can be used such that the rod diameter and the curved surface diameter at the engagement point are the same. The pivotable adjustment rod assembly 60 is rotated down toward the lower clamp jaw 12, however, because the largest diameter rod 90 is engaged with the clamp, the pivotable adjustment rod assembly 60 does not pivot downward as much as with the smaller diameter rod 70. The pivot pin 40 and the keeper clamp 50, however, still allow the pivotable adjustment rod assembly 60 to maintain its alignment because they allow a full range of rotation about the pivot pin 40, by rotating independently from the upper and lower clamp jaws.

The surface 130 above the interior curved surface 32 of the lower clamp jaw 12 is angled away from the interior curved surface 32 as can be seen in FIGS. 5-7. The side 140 of the upper clamp jaw 14 that is adjacent to the lower clamp jaw 12 is angled away from the lower clamp jaw 12 when the upper clamp jaw 14 is in the closed position, best shown in FIG. 5. This allows the upper clamp jaw 14 to rotate from the fully opened position to the fully closed position without coming into contact with the lower clamp jaw 12. In the fully open position, the angled surface 130 of the lower clamp jaw 12 and the angled side 140 of the upper clamp jaw 14 are aligned and are almost in contact with each other, as shown in FIG. 2. As the upper clamp jaw 14 is rotated downward to engage the various size rods, the angled side 140 of the upper clamp jaw 14 moves further away from the angled surface 130 of the lower clamp jaw 12. This allows the upper clamp jaw 14 to rotate from a fully closed position to a fully open position without any interference between the upper and lower clamp jaws.

While embodiments and applications of this invention have been shown and described, it would be apparent to those skilled in the art that other modifications are possible without departing from the inventive concepts herein. For example, the clamp jaws 12 and 14 may be slidably or otherwise connected, rather than hinged, and the pivotable adjustment rod mechanism 60 may be in the form of any adjustment mechanism such as a hydraulic piston and cylinder, a ratchet mechanism or the like. The invention, therefore, is not to be restricted except in the spirit of the claims that follow.

What is claimed is:

1. A multi-sized clamp for rods of different diameters comprising:
a pair of clamp jaws interconnected for allowing relative movement of said clamp jaws in a direction away from each other and in a direction toward each other in a clamping position, each of the clamp jaws having curved interior surfaces comprising curves of at least two diameters matching the curved interior surfaces of the other clamp jaw.

2. A multi-sized clamp of claim 1 wherein said curved interior surfaces having the smallest of said at least two diameters is comprised of a continuous curved surface on each said clamp jaw.

3. A multi-sized clamp of claim 2, wherein said curved interior surfaces having a diameter larger than said smallest of said at least two diameters is comprised of a pair of curved surfaces on each of said clamp jaw with the continuous curved surface positioned between said pair of curved surfaces on each said clamp jaw.

4. The multi-sized clamp of claim 3 wherein said curved interior curved surfaces have three diameters and the largest diameter curved surfaces is comprised of a second pair of curved surfaces on each of said clamp jaw with the first said pair of curved surfaces positioned between the second said pair of curved surfaces on each said clamp jaw.

5. The multi-sized clamp of claim 4 wherein the three diameters of the curved surfaces are 0.590 inches, 0.620 inches, and 0.748 inches.

6. The multi-sized clamp of claim 1, 2, 3, 4 or 5 further comprising means adjustably interconnecting said pair of clamp jaws for causing said relative movement.

7. A multi-sized clamp for rods of different diameters comprising:
a pair of clamp jaws with interconnecting means for allowing relative movement of said clamp jaws in a direction away from each other and in a direction toward each other in a clamping position, the clamp jaws having curved interior surfaces comprising curves of at least two diameters;
said interconnecting means comprising a hinge and a pivotable adjustment rod that when rotated in one direction moves the clamp jaws toward each other and when rotated the opposite direction moves the clamp jaws away from each other.

8. A multi-sized clamp of claim 7 wherein said pivotable adjustment rod comprises:
a spindle having a narrow end containing a threaded hole, the exterior of the spindle being threaded;
retaining means for said spindle;
a pivot pin with a threaded hole through the side of the pin; and
a keeper clamp with a hole through the side of the keeper clamp.

9. A multi-sized clamp of claim 8, wherein said spindle engages with said threaded hole in said pivot pin, said narrow end with the threaded hole of said spindle engaged with said retaining means, said narrow end of said spindle passing through said first hole in said keeper clamp and the retaining means engaging with the side of said keeper clamp.

10. The multi-sized clamp of claim 9 wherein said retaining means is a screw.

11. The multi-sized clamp of claim 9 wherein said retaining means is a retaining ring.

12. The multi-sized clamp of claim 9 wherein said retaining means is a nut.

13. The multi-sized clamp of claim 9 wherein one of said clamp jaws contains a hole to receive said pivot pin and said other clamp jaw contains a hole to receive said keeper clamp.

14. The multi-sized clamp of claim 9 wherein said keeper clamp contains a flat surface that engages with the retaining means.

15. The multi-sized clamp of claim 7 wherein the smaller diameter curved interior surface is generally in the middle of said clamp jaws interior surface and the larger diameter curved interior surface is on both sides of the smaller diameter curved surface.

16. The multi-sized clamp of claim 7 wherein said clamp jaws have curved interior surfaces comprising curves of at least three different diameters.

17. The multi-sized clamp of claim 16 wherein a smallest diameter curved interior surface is generally in the middle of said clamp jaws interior surface, a medium diameter curved interior surface is on both sides of the smallest diameter curved surface, and a largest diameter curved interior surface is on both sides of the medium diameter curved interior surface.

18. The multi-sized clamp of claim 17 wherein the diameters of the curved surfaces are 0.590 inches, 0.620 inches, and 0.748 inches.

19. The multi-sized clamp of claim 7 wherein the first clamp jaws contains a slot and the second clamp jaw contains a narrow section, the narrow section of second clamp jaw and slot of first clamp jaw containing holes, the narrow section of the second clamp jaw fitting inside the slot of the first clamp jaw, the holes in the clamp jaws aligned, and a pin sized to fit in the holes.

20. The multi-sized clamp of claim 7 wherein the first clamp jaw comprises a body extending from the clamp jaw, the body containing a clamp.

21. The multi-sized clamp of claim 21 wherein said clamp of said first clamp jaw body comprises an opening which can be varied in size and a closing mechanism for increasing and decreasing the size of the opening.

22. The multi-sized clamp of claim 21 wherein said closing mechanism comprises a threaded spindle with a threaded hole in one end and a handle on the opposite end, a screw and a threaded insert.

23. The multi-sized clamp of claim 22 wherein said body contains a threaded hole sized to fit said closing mechanism, said threaded insert threadably engaged with said threaded hole, said threaded spindle threadably engaged with said threaded insert and said screw threadably engaged with said threaded hole in said threaded spindle, said closing mechanism decreasing said opening in said body when turned in one direction and increasing said opening in said body when turned in the opposite direction.

24. A multi-sized clamp for rods of different diameters comprising:
a first clamp jaw containing a curved interior surface, a first pair of holes and a second pair of holes and a slot between the first and second pair of holes and cut into the lower clamp jaw above the interior curved surface, the interior curved surface containing curves of at least two different diameters;
a second clamp jaw containing a curved interior surface, a first hole and a second hole, a section of the clamp jaw narrower than the other section of the clamp jaw, the narrower section containing the first hole and sized to fit within said slot in said first clamp jaw;
a hinge pin sized to fit in said first hole in said first clamp jaw and said first hole in said second clamp jaw which allows said second clamp jaw to rotate downward toward said first clamp jaw;
a pivot pin sized to fit in said second holes in first clamp jaw, the pivot pin containing a threaded hole;
a keeper clamp sized to fit in said second hole in said second clamp jaw, the keeper clamp containing a flat surface on each side of a hole through the keeper clamp;
a spindle having an end engaging one said flat surface on said keeper clamp and having a threaded hole in said end;
a screw threadably engaging said threaded hole in said spindle and engaging the other said flat surface on said keeper clamp;
said spindle, screw and keeper clamp cooperatively engaged to allow rotation of said spindle and screw on the axis of said keeper clamp hole while limiting axial movement therebetween; and
said spindle having an exterior threaded and sized to fit said threaded hole in said pivot pin, so that as the spindle is turned in one direction said second clamp jaw moves toward said first clamp jaw and as the spindle is turned in the opposite direction said second clamp jaw moves away from said first clamp jaw.
